(19) United States
(12) Patent Application Publication
(10) Pub. No.: US 2018/0057193 A1
(43) Pub. Date: Mar. 1, 2018

(54) Simulated Gravity Device

(71) Applicant: David Byron Douglas, Winter Park, FL (US)

(72) Inventor: David Byron Douglas, Winter Park, FL (US)

(21) Appl. No.: 15/679,329

(22) Filed: Aug. 17, 2017

Related U.S. Application Data
(60) Provisional application No. 62/378,291, filed on Aug. 23, 2016.

(51) Int. Cl. B64G 7/00; B64G 1/60

(52) U.S. Cl. CPC B64G 7/00; B64G 1/60

(57) ABSTRACT

A simulated gravity device method and apparatus is presented. The simulated gravity device (SGD) is disposed in mechanical communication with a spacecraft. The SGD is rotatable about a central axis, and is capable of supporting a person therein. The SGD is rotatable at a speed resulting in various forces, said various forces dependent on a rotation speed of said SGD and on a position within said SGD. The SGD is able to simulate the force of gravity on an astronaut.

### BACKGROUND

There are multiple threats to astronauts involved in spaceflight. One of the key threats to astronauts in space is the threat of microgravity. Microgravity has been shown to cause medical problems during both short term and long term exposures. During short term exposures to microgravity, the physiologic effects from microgravity-induced fluid shifts can present symptomatically with nausea, motion sickness and cephalad fluid shifts, headache as well as back pain, but fortunately these effects are temporary.

During long term exposures to microgravity, a critical threat is bone loss with a rate of one percent per month. The rates of bone loss can be decreased with exercise and short-term impulsive mechanical stimuli. However, exercise and short-term impulsive mechanical stimuli cannot entirely stop microgravity induced bone loss. A fracture on a long-term space mission would be hugely detrimental to mission success. Another critical threat is spaceflight induced visual impairment, which is associated with elevated intracranial pressure, is a major threat as astronauts have suffered visual impairment due to spaceflight. While the mechanism of visual impairment and elevated intracranial pressure is not well understood, microgravity-induced fluid shifts and decreased Cerebral Spinal Fluid (CSF) absorption is a hypothesis. While no current method to mitigate the visual impairment and elevated intracranial pressure exists, National Aeronautics and Space Administration's (NASA's) Vision Impairment and Intracranial Pressure (VIIP) project is actively researching this topic. The development of visual impairment or intracranial hypertension would on long-term space mission would be hugely detrimental to mission success and would endanger the lives of the astronauts.

### SUMMARY

In order to successfully complete long-term space missions, the threat of microgravity induced bone loss, visual impairment and intracranial hypertension must be overcome. In addition, the unique environment in space provides the ability to perform onboard research projects under microgravity that would be impossible to complete on Earth, which include fields such as chemistry, biology and physics.

The presently disclosed method and apparatus provides a simulated gravity room (SGR) on a space station for the purpose of overcoming the threats of the microgravity-induced health threats to astronauts. Additionally, this low-simulated gravity room can be used for other activities such as research or manufacturing.

The concepts disclosed herein should not be viewed as being limited to use in a microgravity environment. For example, aspects could be used on Earth to provide transient artificial increased forces on the body including the musculoskeletal system to maintain or improve bone mineral density in those diagnosed with osteoporosis and osteopenia or those at risk for osteoporosis and osteopenia.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. The drawings are not necessarily to scale, emphasis instead being placed upon illustrating the principles of the invention.

FIGS. 1A and 1B are diagrams of the Simulated Gravity Device (SGD) in accordance with a particular embodiment of the present invention.

FIG. 2 is an overview of the cerebrospinal fluid and venous pressures in various positions.

FIGS. 3A and 3B are diagrams of the forces on the femur while exposed to gravity and in a microgravity environment.

FIG. 4 is a graph showing the relationship between the distances from the center of the SGR to the centripetal acceleration in accordance with a particular embodiment of the present invention.

FIG. 5 is a flow diagram of a method of providing a simulated gravity device in accordance with a particular embodiment of the present invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

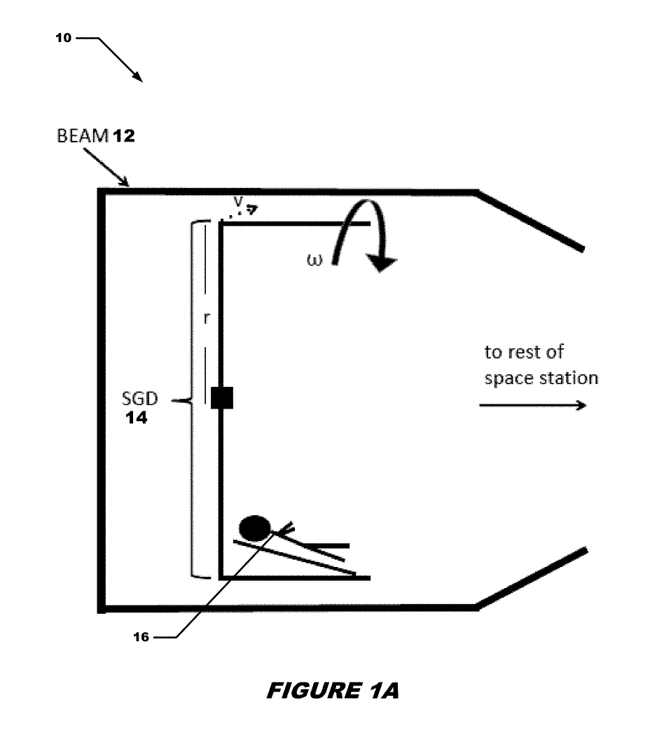

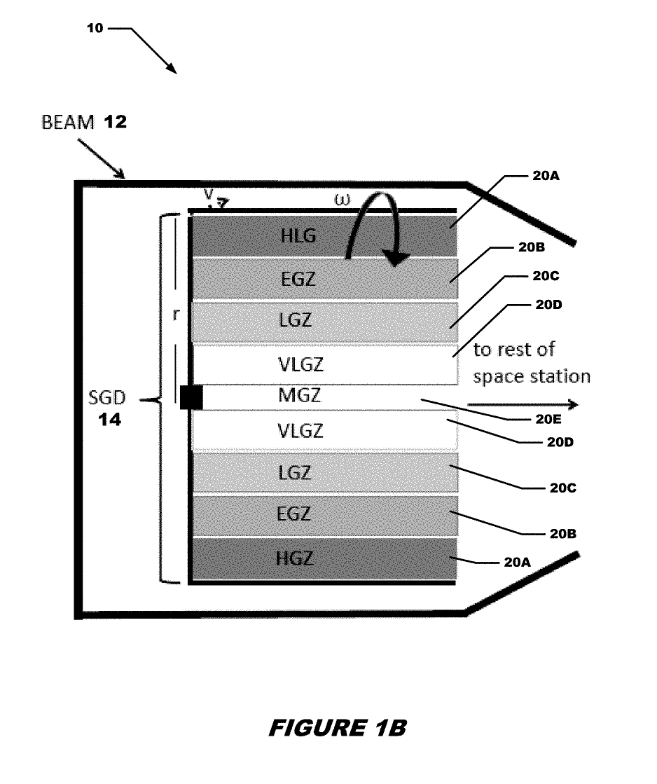

Space provides many important areas of research, including experiments in the microgravity environment. When the astronauts have completed their research activities during the day, they go to sleep in microgravity on the International Space Station and all other space stations to date. Thus, they are spending their entire 24 hours per day in a microgravity environment. This presently disclosed method and apparatus provide for simulated gravity during sleep, which is referred to as the Simulated Gravity Room (SGR) 12 as illustrated in FIGS. 1A and 1B. In the preferred embodiment, the SGR is located within the BEAM. A cross-section of the cylindrical device with radius, r, is shown. The point about which the individual rotates is denoted by the black rectangle. The centripetal acceleration, ω, and angular velocity, v, will be determined by optimization studies and/or astronaut preference. The angle at which the angle of the head of the bed is tilted would also be determined by optimization studies and/or astronaut preference. The open area at the right of the image shows the passageway into the rest of the space station.

The key systems envisioned within the process and the elements and sub-elements within these systems are described below. The spacecraft element would consist of sectioned off area 12 of the spacecraft or an inflatable space station room extending outside of the spacecraft, such as the Bigelow Expandable Activity Module (BEAM). The spacecraft would provide all of the supporting equipment for the SGD 14 including the electrical power supply, mechanical supporting structures, air conditioning controls and passageway into the SGD.

A control sub-element provides the controls for the centrifuge 14 including the ability to manipulate the acceleration and stopping controls. A power sub-element hooks up to the power supply of the space station.

A centrifuge device sub-element is used to achieve an acceleration of the centrifuge equal to the gravitational force on Earth, which is 9.8 m/s². The formula for centripetal acceleration is a=v²/r where a is the acceleration, v is the velocity of rotation and r is the radius.

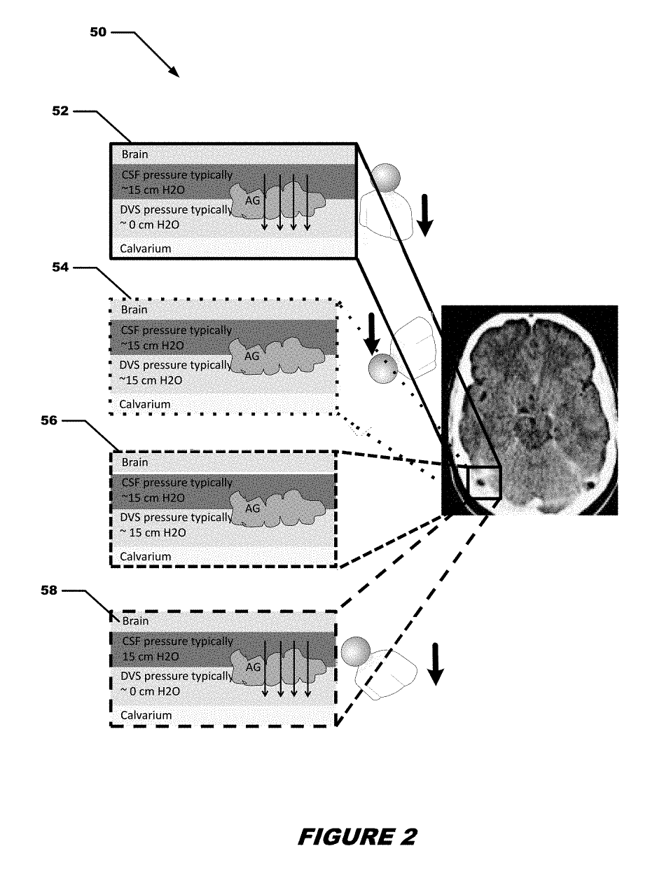

Rearranging the equation, the velocity of rotation would be equal to v=\sqrt{a×r}. The BEAM has a diameter of approximately 3.2 meters (NBC). Assuming the radius of the centrifuge of the SGD is 1.5 meters and the desired acceleration at r=1.5 meters is 9.8 m/s², then the velocity of rotation would be equal to \sqrt{9.8 m/s²×1.5 m} or ˜3.8 m/s. Please see Table 1-3 and FIG. 2 for illustration on how the centripetal acceleration (aka simulated gravity level) changes with respect to distance.

Additional features of the centrifuge device sub-element include altered direction of rotation and alteration in the speed to achieve varying accelerations, which would be provided by the control sub-element.

Furthermore, the pathway to entering the SGR could be a funnel such that each distance further into the SGR would have a slightly wider diameter. This would create easier access to astronauts getting into the SGR.

TABLE 1
Configuration within the current BEAM would yield approximately
38 m² (or 406 ft²) of workable floor space.

| | | Speed of | | Speed | | |
|---|---|---|---|---|---|---|
| Dis- | Circum- | Rotation | | of | | |
| tance | ference | of SGR | Time | Rotation | | |
| from | at distance | (in | for | of | Accel- | |
| Center | from the | degrees | rotation | SGR | eration | G |
| (m) | center (m) | ω/second) | (s) | (m/s) | (m/s/s) | forces |
| 0.0 | 0.00 | 150 | 2.40 | 0.00 | 0.00 | 0.00 |
| 0.5 | 3.14 | 150 | 2.40 | 1.31 | 3.43 | 0.35 |
| 1.0 | 6.28 | 150 | 2.40 | 2.62 | 6.85 | 0.70 |
| 1.5 | 9.42 | 150 | 2.40 | 3.93 | 10.28 | 1.05 |

TABLE 2
Configuration within a slightly larger BEAM (radius of 3 m) would yield approximately
94 m² (or 1014 ft²) of workable floor space with less of a gradient of change in
acceleration over distance from the center.

| | | | Speed of | | | | |
|---|---|---|---|---|---|---|---|
| | | | Rotation | | | | |
| | Distance | Circumference | of SGR | Time | Speed of | | |
| | from | at distance | (in | for | Rotation | | |
| Body | Center | from the | degrees ω/ | rotation | of SGR | Acceleration | G |
| position | (m) | center (m) | second) | (s) | (m/s) | (m/s/s) | forces |
| | 0.0 | 0.00 | 120 | 3.0 | 0.00 | 0.00 | 0.00 |
| Head | 1.0 | 6.28 | 120 | 3.0 | 2.09 | 4.39 | 0.45 |
| when | | | | | | | |
| standing | | | | | | | |
| Head | 2.0 | 12.57 | 120 | 3.0 | 4.19 | 8.77 | 0.90 |
| when | | | | | | | |
| seated | | | | | | | |
| Feet | 3.0 | 18.85 | 120 | 3.0 | 6.28 | 13.16 | 1.34 |

TABLE 3
Configuration within an even larger BEAM (radius of 4 m) would yield approximately
151 m² (or 1623 ft²) of workable floor space with less of a gradient of change
in acceleration over distance from the center.

| | | | Speed of | | | | |
|---|---|---|---|---|---|---|---|
| | | | Rotation | | | | |
| | | | of SGR | | | | |
| | Distance | Circumference | (in | Time | Speed of | | |
| | from | at distance | degrees | for | Rotation | | |
| Body | Center | from the center | ω/ | rotation | of SGR | Acceleration | G |
| position | (m) | (m) | second) | (s) | (m/s) | (m/s/s) | forces |
| | 0.0 | 0.00 | 90 | 4.0 | 0.00 | 0.00 | 0.00 |
| | 1.0 | 6.28 | 90 | 4.0 | 1.57 | 2.47 | 0.25 |
| Head | 2.0 | 12.57 | 90 | 4.0 | 3.14 | 4.93 | 0.50 |
| when | | | | | | | |
| standing | | | | | | | |
| Head | 3.0 | 18.85 | 90 | 4.0 | 4.71 | 7.40 | 0.76 |
| when | | | | | | | |
| seated | | | | | | | |
| Feet | 4.0 | 25.13 | 90 | 4.0 | 6.28 | 9.87 | 1.01 |

A sleeping quarters sub-element is large enough to allow for one or more people 16 people. There are multiple manners in which the bed could be arranged to achieve simulated gravity, with the preferred arrangement seen in FIG. 1B. In order to establish a cerebrospinal fluid (CSF) to venous pressure gradient at the arachnoid granulations within the head, the bed will need to be at an incline so that the head of the bed is elevated. When the head of the bed is elevated and simulated gravity is provided through centripetal acceleration, then the pressure within the venous system will lower and on physical examination or ultrasound examination the neck veins will collapse. The lower venous pressure will restore the CSF-venous gradient allowing for adequate resorption of CSF during sleep. Furthermore, the microgravity-induced bone loss, which is known to also cause kidney stones could be mitigated. Even at rest while on Earth, the bones are subjected to forces of gravity, but there is no such force while at rest in space. Therefore, just being present in the SGR would mitigate microgravity-induced bone loss. Alternative activities could be performed in the SDG, such as reading or visiting with family via videoconferencing. Privacy walls could be established by sectioning off portions of SGR for astronaut quarters. Furthermore, the air within the SGR would also experience centripetal force, which would improve convection and prevent stasis of regions of CO₂ buildup during sleeping.

A recreation sub-element would provide a place where astronauts could be together in one space to enjoy recreational games (e.g., ping pong, noting that the arc of the ping pong ball would be highly unique in such a centripetal acceleration field) or work activities. Physical activity could also be performed in such a room, which would be able to help improve both bone health and muscle health. Such a room could also be used during initial spaceflight adaptation to prevent the initial symptoms (e.g. nausea, disorientation) during the first hours and days of spaceflight.

An accessories sub-element includes all of the supporting structures conducive to sleeping, such nightstand with storage compartments, reading lamp, fan for adequate airflow exchange, etc.

A research sub-element is also provided. On Earth, research can be conducted in the range of gravitational force at 9.8 m/s² or in centrifuges at higher acceleration fields if in a centrifuge. On spacecraft, research is currently conducted at microgravity levels (˜0 m/s²) as shown in FIG. 1B. The large centrifuge would provide the possibility to perform research at low acceleration fields (i.e., ranging from microgravity levels up to 9.8 m/s²), which are not possible on Earth. The centripetal acceleration (or simulated gravity) would vary depending on the distance from the center of the centrifuge. Thus, research projects performed in the center of the centrifuge would be in the microgravity zone (MGZ). Not that this portion of the centrifuge provides nothing unique that could not be done elsewhere in the spacecraft. However, research projects aimed in the very low gravity zones (VLGZ) would take place near the center of the centrifuge (FIG. 1). Research projects aimed in the low gravity zones (LGZ) would take place slightly further away from the center of the centrifuge. Research projects aimed in the Earth gravity zones (EGZ) would take place even further from the center of the centrifuge. Research projects aimed in the high gravity zones (HGZ) would take place even further from the center of the centrifuge. Note that the VLGZ and the LGZ in the SGR provide unique environments that cannot be attained elsewhere in the spacecraft or on Earth. A system of elevators could bring the research experiment closer to the center of the SGR to provide less centripetal acceleration or farther from the center of the SGR to provide more centripetal acceleration. Examples of research projects that could be performed in the SGR, but more specifically the LGZ and VLGZ include, but are not limited to chemistry, physics, biology and medicine. The environment described is unique in the fact that the gravity changes substantially depending on the distance from the center. If a human was standing in the SGR with the head closest to the center of rotation and the feet at a further distance radially, then the head would experience less centripetal acceleration than the trunk and the trunk would experience less centripetal acceleration than the legs. Such an environment is unique to anything the human has ever experiences; thus, it is of paramount importance that a physician have careful monitoring of the astronaut during the first attempts in this environment. Specifically, the fluid property of blood may cause more pooling in the legs on this environment as compared to Earth. Therefore, careful physical examination and ultrasound measurements of the blood flow and organs would be required to determine safety. Furthermore, it may be deemed necessary to wear compression stockings or thigh high socks to prevent blood from pooling in the legs because of the unique environment. This is another reason why it is important to have stringent monitoring of astronauts during the initial testing of this device while on the spacecraft.

A manufacturing sub-element is also provided. Should research in the unique environments of the VLGZ and LGZ prove successful in yielding products that are unable to be developed in MGZ or on Earth, large scale manufacturing could be performed in such environments in space. As an example of a type of manufacturing that would be readily available once the SGR is installed would be 3D printing. There are some difficulties with 3D printing in microgravity environments, which would immediately be overcome by manufacturing any needed parts onboard the space station via 3D printing in the SGR. As another example, there is some difficulty growing plants in the microgravity environment. Gardening of plants on the SGR would yield improved efficiency and improve sustainability and health of the astronauts onboard the spacecraft.

A ground training sub-element, which is a replica of the above sub-elements to replicate form, fit and function of the system. This will allow the astronauts train with the system prior to any use in space. From a form and fit function, this will ensure the SGD module is compatible with other elements of the spacecraft. Also, specific sleep modules will be constructed to ensure comfort and fit with each astronaut body size and shape. From a function perspective, this sub-element will have pressure devices to test the predicted centrifugal forces with measured forces.

The orientation of the astronaut body within the SGD may change during the course of a particular session. During one period, the body may be perpendicular to a vector from the center of the SGD to the circumference (outer surface). In this orientation, the body would experience a centrifugal force similar to those experienced when one is asleep. If the body were aligned the vector from the center of the SGD to the circumference, this would allow centrifugal forces similar to those experienced while one is standing. The sleeping capsule within the SGD would offer the astronaut the capability to rotate the capsule, to replicate changing positions (e.g., from sleeping on the back to sleeping on one's side). Other variations may include, but are not limited to, sitting in a chair.

During experimentation, a finding may be that time of use of the SGD only while sleeping with centrifugal forces equal to Earth's gravitational force may not be sufficient to offset the adverse health related conditions of operating in micro gravity for prolonged periods. If this were the case, then an increase in centrifugal forces may be necessary to ensure health. For example, an increase in centrifugal force by increasing the rotational speed could increase the force two time that of Earth's gravity, thereby yielding a multiplicative factor for the sleep period in the GSD.

FIG. 2 illustrates the changing venous pressures and changing cerebrospinal fluid (CSF)-venous gradient in multiple settings. The image on the right is a contrast-enhanced axial computed tomography (CT) image of the head showing the calvarium (white), the dural venous sinus (light gray due to contrast material), a hypodense (dark gray) arachnoid granulation within the dural venous sinus and extending to the margin of the subarachnoid space (dark gray) where CSF is contained. Finally, the brain (medium gray) is illustrated. Four settings are shown.

Setting 52 shows a person on Earth in the upright position. Note that in the upright position in a healthy subject, the neck veins are collapsed. The direction of the force of gravity helps pull the blood out of the head and down into the chest. Thus, blood draining the brain is in the state of free fall as it pours down the neck veins and into the chest. Therefore, the venous pressure denoted here is ˜0 cm H₂O as there is no back-pressure exerted on the cerebral veins and arachnoid granulations. The CSF pressure is assumed to be ˜15 cm H₂O for this example. The CSF to venous pressure gradient is therefore 15 cm H₂O.

Setting 54 is for a person on Earth in the head down tilt (HDT) position. Note that in the HDT position, the neck veins are distended because the direction of the force of gravity is opposite of the direction of the venous flow of blood from the head and neck and into the chest. Note that in the HDT position in a healthy subject, the neck veins are distended and there is backpressure exerted against the cerebral vasculature. The neck veins are filled with blood and exert a backpressure onto the cerebral veins, which is denoted here as ˜15 cm H₂O. The CSF pressure is assumed to be ˜15 cm H₂O for this example. Therefore, the CSF to venous pressure gradient is lost and is ˜0 cm H₂O. Without a CSF to venous pressure gradient, absorption of CSF is impaired.

Setting 56 shows a person in microgravity in any position. Note that in microgravity in a healthy subject, the neck veins are distended similarly to the HDT position on Earth due to the natural cephalad shift of fluids and the fact that there is no gravitational assist to pull blood from the head and neck into the chest. Thus, the neck veins are filled with blood and exert a backpressure onto the cerebral veins, which is denoted here as ˜15 cm H₂O. The CSF pressure is assumed to be ˜15 cm H₂O for this example. Therefore, the CSF to venous pressure gradient is lost and is ˜0 cm H₂O. Without a CSF to venous pressure gradient, absorption of CSF is impaired.

Setting 58 shows a person in microgravity in SGSD. Note that the SGSD with the head of the bed elevated, the neck veins will collapse because this situation has similar forces as compared to the upright position on Earth. Thus, blood draining the brain is in the state of free fall as it pours down the neck veins and into the chest. Therefore, the venous pressure denoted here is ˜0 cm H₂O. The CSF pressure is assumed to be ˜15 cm H₂O for this example. The CSF to venous pressure gradient is therefore 15 cm H₂O, which provides an environment favorable for the resorption of CSF.

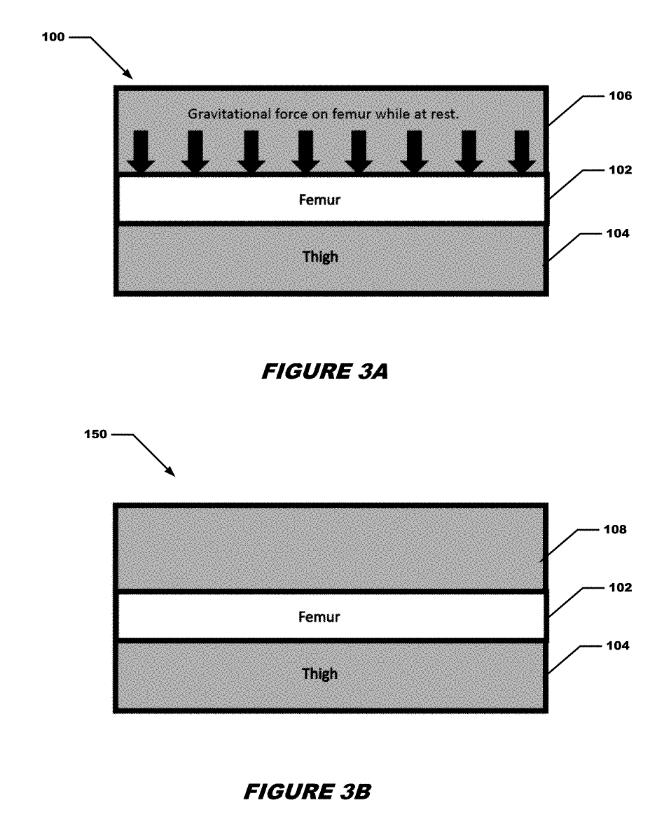

FIGS. 3A and 3B illustrate the overview of the forces of gravity on bone at rest in Earth and on the SGS as well as in the microgravity environment. The large gray rectangle represents the thigh 104. The smaller white rectangle within the thigh represents the femur bone 102.

As shown in FIG. 3A, on Earth and in the SGD, the force of gravity exerts its effect on all structures in the body, but this diagram specifically shows the force exerted by the non-dependent thigh on the femur. When the person rolls over, a new set of forces is exerted on the femur bone. Thus, even at the rest position while the astronaut is asleep the forces of gravity are exerted on the bone. As shown in FIG. 3B, in the microgravity environment of space, there is no skeletal loading.

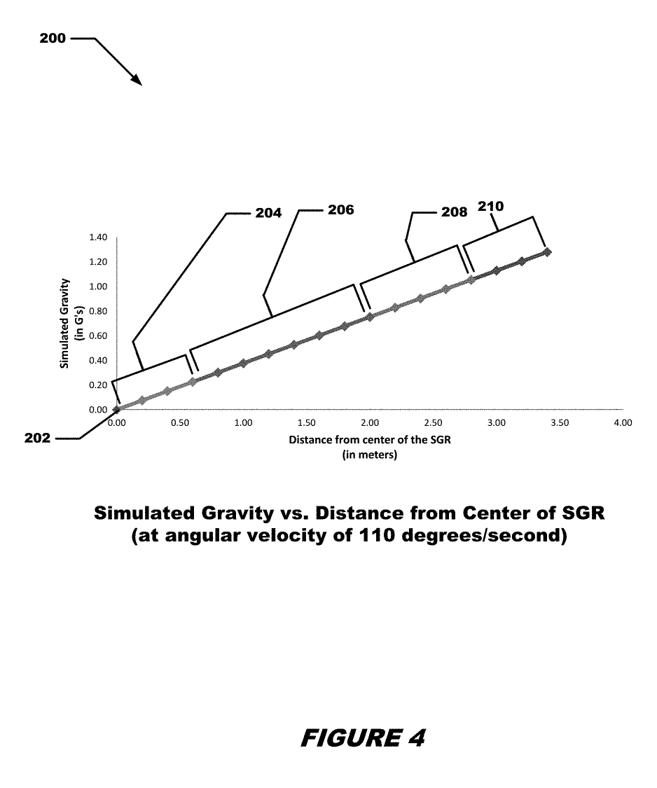

FIG. 4 shows a graph that illustrates the relationship between the distances from the center of the centrifuge element in the SGR to the centripetal acceleration. The chart assumes an angular velocity of 110 degrees per second. There are several zones with associated levels of acceleration and recommended activities at each level. The high gravity zone (HGZ) 210 would have preferred activities such as bone treatment, exercise and possibly research experiments. Note that the bone treatment is hypothesized to be more efficient at higher levels of gravity, which could yield a significant stimulus for maintenance of bone mineral density in a shorter amount of time. The Earth gravity zone (EGZ) 208 has recommended activities including sleeping, recreation and manufacturing (e.g., 3D printing). The low gravity zone (LGZ) 206 has recommended activities including research and manufacturing. The very low gravity zone (VLGZ) 204 has recommended activities including research and manufacturing. Note that the VLGZ and the LGZ would have a unique simulated gravity environment that is not possible on either Earth or elsewhere on the International Space Station. The center of the SGR is where the microgravity zone 202 is located.

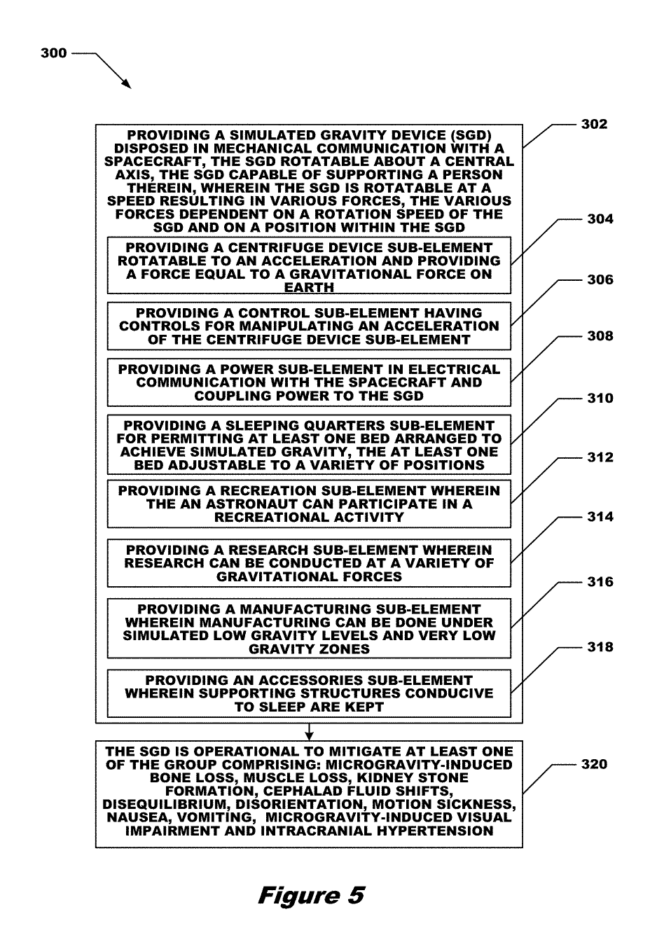

A flow chart of a particular embodiment of the presently disclosed method is depicted in FIG. 5. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 5, a particular embodiment of a method for providing a simulated gravity device is shown. Method 300 begins with processing block 302 which discloses providing a simulated gravity device (SGD) disposed in mechanical communication with a spacecraft, the SGD rotatable about a central axis, the SGD capable of supporting a person therein, wherein the SGD is rotatable at a speed resulting in various forces, the various forces dependent on a rotation speed of the SGD and on a position within the SGD.

Processing block 304 states wherein the providing an SGD includes providing a centrifuge device sub-element rotatable to an acceleration and providing a force equal to a gravitational force on Earth. Processing block 306 recites wherein the providing an SGD includes providing a control sub-element having controls for manipulating an acceleration of the centrifuge device sub-element. Processing block 308 discloses wherein the providing an SGD includes providing a power sub-element in electrical communication with the spacecraft and coupling power to the SGD.

Processing continues with processing block 310 which states wherein the providing an SGD includes providing a sleeping quarters sub-element for permitting at least one bed arranged to achieve simulated gravity, the at least one bed adjustable to a variety of positions. Processing block 312 recites wherein the providing an SGD includes providing a recreation sub-element wherein the astronaut can participate in a recreational activity.

Processing block 314 discloses wherein the providing an SGD includes providing a research sub-element wherein research can be conducted at a variety of gravitational forces. Processing block 316 states wherein the providing an SGD includes providing a manufacturing sub-element wherein manufacturing can be done under simulated low gravity levels and very low gravity zones. Processing block 318 states wherein the providing an SGD includes providing an accessories sub-element wherein supporting structures conducive to sleep are kept.

As shown in processing block 320 the SGD is operational to mitigate at least one of the group comprising: microgravity-induced bone loss, muscle loss, kidney stone formation, cephalad fluid shifts, disequilibrium, disorientation, motion sickness, nausea, vomiting, microgravity-induced visual impairment and intracranial hypertension.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of providing simulated gravity comprising:
providing a simulated gravity device (SGD) disposed in mechanical communication with a spacecraft, said SGD rotatable about a central axis, said SGD capable of supporting a person therein, wherein said SGD is rotatable at a speed resulting in various forces, said various forces dependent on a rotation speed of said SGD and on a position within said SGD.

2. The method of claim 1 wherein said providing an SGD includes providing a centrifuge device sub-element rotatable to an acceleration and providing a force equal to a gravitational force on Earth.

3. The method of claim 2 wherein said providing an SGD includes providing a control sub-element having controls for manipulating an acceleration of said centrifuge device sub-element.

4. The method of claim 1 wherein said providing an SGD includes providing a power sub-element in electrical communication with said spacecraft and coupling power to said SGD.

5. The method of claim 1 wherein said providing an SGD includes providing a sleeping quarters sub-element for permitting at least one bed arranged to achieve simulated gravity, said at least one bed adjustable to a variety of positions.

6. The method of claim 1 wherein said providing an SGD includes providing a recreation sub-element wherein said an astronaut can participate in a recreational activity.

7. The method of claim 1 wherein said providing an SGD includes providing a research sub-element wherein research can be conducted at a variety of gravitational forces.

8. The method of claim 1 wherein said providing an SGD includes providing a manufacturing sub-element wherein manufacturing can be done under simulated low gravity levels and very low gravity zones.

9. The method of claim 1 wherein said providing an SGD includes providing an accessories sub-element wherein supporting structures conducive to sleep are kept.

10. The method of claim 1 wherein said SGD is operational to mitigate at least one of the group comprising: microgravity-induced bone loss, muscle loss, kidney stone formation, cephalad fluid shifts, disequilibrium, disorientation, motion sickness, nausea, vomiting, microgravity-induced visual impairment and intracranial hypertension.

11. An apparatus for providing simulated gravity comprising:
a simulated gravity device (SGD) disposed in mechanical communication with a spacecraft, said SGD rotatable about a central axis, said SGD supporting a person therein, wherein said SGD is rotatable at a speed resulting in various forces, said various forces dependent on a rotation speed of said SGD and on a position within said SGD.

12. The apparatus of claim 11 wherein said SGD includes a centrifuge device sub-element rotatable to an acceleration and providing a force equal to a gravitational force on Earth.

13. The apparatus of claim 12 wherein said SGD includes a control sub-element having controls for manipulating an acceleration of said centrifuge device sub-element.

14. The apparatus of claim 11 wherein said SGD includes providing a power sub-element in electrical communication with said spacecraft and coupling power to said SGD.

15. The apparatus of claim 11 wherein said SGD includes a sleeping quarters sub-element for permitting at least one bed arranged to achieve simulated gravity, said at least one bed adjustable to a variety of positions.

16. The apparatus of claim 11 wherein said SGD includes a recreation sub-element wherein said an astronaut can participate in a recreational activity.

17. The apparatus of claim 11 wherein said SGD includes a research sub-element wherein research can be conducted at a variety of gravitational forces.

18. The apparatus of claim 11 wherein said SGD includes a manufacturing sub-element wherein manufacturing can be done under simulated low gravity levels and very low gravity zones.

19. The apparatus of claim 11 wherein said SGD includes an accessories sub-element wherein supporting structures conducive to sleep are kept.

20. The apparatus of claim 11 wherein said SGD is operational to mitigate at least one of the group comprising: microgravity-induced bone loss, muscle loss, kidney stone formation, cephalad fluid shifts, disequilibrium, disorientation, motion sickness, nausea, vomiting, microgravity-induced visual impairment and intracranial hypertension.

21. A method and apparatus to provide transient artificial increased forces on the body including the musculoskeletal system to patients on earth to maintain or improve bone mineral density in those diagnosed with osteoporosis and osteopenia or those at risk for osteoporosis and osteopenia.
